(19) United States
(12) Patent Application Publication
(10) Pub. No.: US 2016/0369778 A1
(43) Pub. Date: Dec. 22, 2016

(54) METHOD OF ASSEMBLING A WIND TURBINE

(71) Applicant: Daniel E. DAVIS, San Benito, TX (US)

(72) Inventor: Daniel E. DAVIS, San Benito, TX (US)

(21) Appl. No.: 15/188,610

(22) Filed: Jun. 21, 2016

Related U.S. Application Data
(63) Continuation-in-part of application No. 15/010,024, filed on Jan. 29, 2016.
Application No. 15/010,024 is a division of application No. 13/468,718, filed on May 10, 2012, now Pat. No. 9,261,072.
(60) Provisional application No. 61/484,769, filed on May 11, 2011.

(51) Int. Cl. F03D 13/10; E04H 12/34; F03D 13/20; F03D 1/00; F03D 9/00

(52) U.S. Cl. CPC F03D 13/10; F03D 1/001; F03D 9/003; F03D 13/20; E04H 12/342

(57) ABSTRACT

A method of assembling a wind turbine comprising placing a tower base in an upright position. The tower base includes a tower base guide rail and a carriage. The carriage is movable along the tower base guide rail and includes a crane attached thereto. The method further comprises connecting a first tower body member to the tower base to form a turbine tower. The first tower body member includes a first tower body guide rail and is connected to the tower base in a manner such that the tower base guide rail axially aligns with the first tower body guide rail to collectively form a rail track. The carriage is movable up and down the turbine tower along the rail track.

### CROSS-REFERENCE TO RELATED APPLICATIONS

This application is a continuation-in-part application claiming the benefit of pending U.S. nonprovisional application Ser. No. 15/010,024, which was filed on Jan. 29, 2016. U.S. nonprovisional application Ser. No. 15/010,024 claims the benefit of U.S. nonprovisional application Ser. No. 13/468,718, which was filed on May 10, 2012. U.S. nonprovisional application Ser. No. 13/468,718, which issued as U.S. Pat. No. 9,261,072 on Feb. 16, 2016, claims the benefit of U.S. provisional application 61/484,769, which was filed on May 11, 2011. Each of the foregoing applications mentioned within this paragraph are herein incorporated by reference.

### BACKGROUND OF THE DISCLOSURE

Field of the Disclosure

Embodiments of the present disclosure generally relate to a wind turbine.

Description of the Related Art

A wind turbine includes a rotor having a hub and multiple (typically three) blades connected to the hub. The rotor is connected to an input drive shaft of a gearbox. The blades transform wind energy into torque that drives a generator connected to an output shaft of the gearbox. The gearbox steps up the inherently low rotational speed of the rotor for the generator to efficiently convert the rotational mechanical energy to electricity, which is fed into a utility grid. Gearless direct drive wind turbines also exist. The drive shafts, generator, gearbox and other components are typically mounted within a nacelle that is positioned on top of a tower that may be a truss or tubular.

FIG. 1 illustrates a prior art lattice boom crawler crane having just assembled a wind turbine. To assemble the wind turbine, a high capacity lattice boom crane is required to hoist the nacelle on to the tower and then to hoist the rotor on to the nacelle. Since the wind turbines are usually located in remote locations, costs of deploying the crane to the wind turbine site can become substantial. Further, to increase capacity and efficiency, larger towers, longer blades, and heavier nacelles are currently in development, further exacerbating the installation cost (and maintenance cost if the nacelle must be removed) up to the point that it may be cost prohibitive to install the larger wind turbines, especially if the height capacity of the conventional lattice boom crane is exceeded.

### SUMMARY OF THE DISCLOSURE

Embodiments of the present disclosure generally relate to a wind turbine. In one embodiment, a method for assembling a wind turbine comprises: placing a tower base in an upright position, the tower base including a tower base guide rail and a carriage, the carriage being movable along the tower base guide rail and including a crane attached thereto; and connecting a first tower body member to the tower base to form a turbine tower, the first tower body member including a first tower body guide rail and being connected to the tower base in a manner such that the tower base guide rail axially aligns with the first tower body guide rail to collectively form a rail track, the carriage being movable up and down the turbine tower along the rail track.

In another embodiment, a wind turbine comprises: a turbine tower including a tower base and a plurality of tower body members, the tower base including a tower base guide rail, each of the plurality of tower body members including a tower body guide rail, the tower base and the plurality of tower body members being connected in a manner such that the tower base guide rail and the tower body guide rails collectively form a vertically extending rail track; and a carriage movable along the vertically extending rail track, the carriage including a bearing that is adapted to releasably connect a crane platform having a crane positioned thereon to the turbine tower.

In another embodiment, a method of assembling a wind turbine comprises: placing a tower base in an upright position, the tower base including a tower base guide rail and a carriage, the carriage including a rotating pole assembly rotatable between a loading position and an unloading position; connecting a first tower body member to the rotating pole assembly while the rotating pole assembly is in the loading position; moving the carriage upwardly to a top of the tower base along the tower base guide rail while the rotating pole assembly is in the loading position; and rotating the rotating pole assembly from the loading position to the unloading position such that the first tower body member is positioned above the tower base.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a prior art lattice boom crawler crane having just assembled a wind turbine.

FIGS. 2A-2N illustrate one embodiment of assembling a wind turbine in accordance with the present disclosure. FIG. 2A illustrates placing a tower base in an upright position, with a carriage connected to the tower base. FIG. 2B illustrates placing the tower base on a pad. FIG. 2C illustrates a crane platform connected to the carriage. FIG. 2D illustrates positioning a crawler crane onto the crane platform using a ramp. FIG. 2E illustrates a crane rope of the crawler crane connected to a first tower body member. FIG. 2F illustrates connecting the first tower body member to the tower base to form a turbine tower. FIG. 2G illustrates additional tower body members connected to the turbine tower, with the crane rope of the crawler crane connected to a top tower body member. FIG. 2H illustrates connecting the top tower body member to the turbine tower. FIG. 2I illustrates connecting a nacelle and hub to the carriage in a vertical position. FIG. 2J illustrates connecting blades to the hub to form a rotor. FIG. 2K illustrates the nacelle and rotor raising along a rail track. FIG. 2L illustrates the nacelle and rotor pivoting from the vertical position to a horizontal position. FIGS. 2M and 2N illustrate the nacelle and rotor in the horizontal position and ready for operation.

FIGS. 3A-3D illustrates another embodiment of assembling a wind turbine in accordance with the present disclosure. FIG. 3A illustrates positioning a stiff leg crane onto the crane platform that is connected to the carriage. FIG. 3B illustrates a crane rope of the stiff leg crane connected to the first tower body member. FIG. 3C illustrates additional tower body members connected to the turbine tower, with the crane rope of the stiff leg crane connected to the top tower body member. FIG. 3D illustrates connecting the top tower body member to the turbine tower.

FIGS. 4A-4D illustrate an embodiment of the carriage in accordance with the present disclosure. FIG. 4A illustrates a top view of the carriage connected to the tower base. FIG. 4B illustrates a side view of the carriage connected to the tower base. FIG. 4C illustrates the side view of the carriage connected to the tower base, with a portion of a body of the carriage broken away to show trolley wheels of the carriage engaging a guide rail of the tower base. FIG. 4D illustrates the side view of the carriage connected to the tower base, with a further portion of the body of the carriage broken away to show a pinion gear of the carriage interlocking with a rack of the tower base.

FIGS. 5A-5C illustrate another embodiment of assembling a wind turbine in accordance with the present disclosure, the wind turbine being assembled using a rotating pole assembly attached to the carrier. FIG. 5A illustrates the rotating pole assembly in the loading position raising a tower body member that is attached thereto. FIG. 5B illustrates the rotating pole assembly after having rotated from the loading position to the unloading position such that the tower body member is located above a tower base. FIG. 5C illustrates the rotating pole assembly raising an additional tower body member in the loading position to a top of an existing turbine tower.

FIG. 6 illustrates an additional support system that may be utilized for enhanced safety when assembling a wind turbine. The additional support system includes angles, steel cables, and an anchor system.

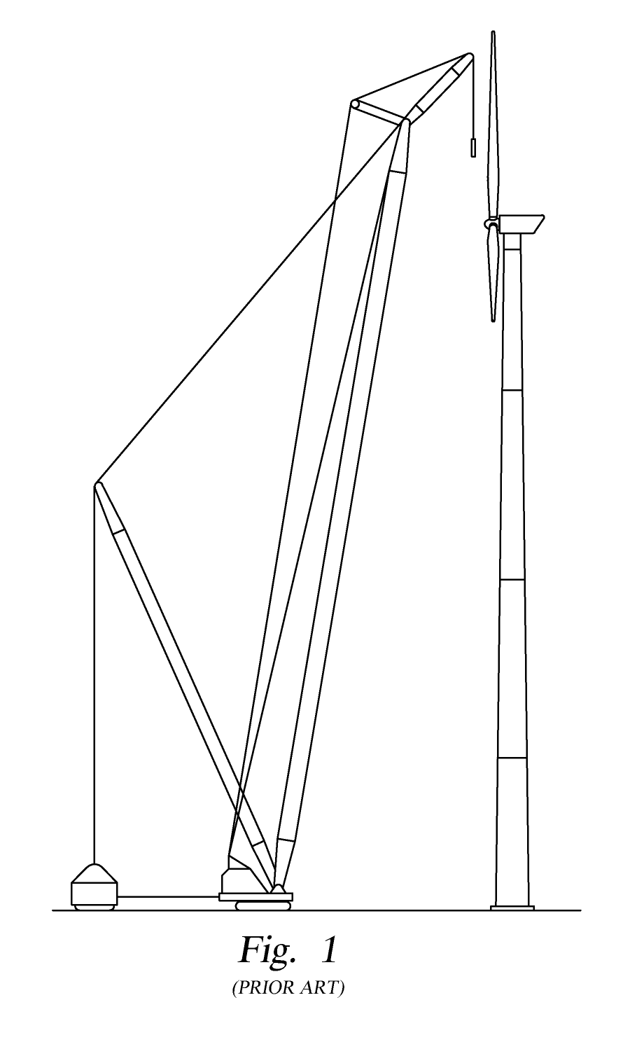

### DETAILED DESCRIPTION

The present disclosure relates to a wind turbine 1 and methods of assembling the wind turbine. After assembly, the wind turbine 1 comprises a turbine tower 2, a nacelle 6, and a hub 7. Blades 9 are attached to the hub 7, thereby forming a rotor. The nacelle 6 and the hub 7 are operatively connected to the turbine tower 2 via a carriage 10. The turbine tower 2 comprises a tower base 17 and tower body members 16. Depending upon the shape of the tower base 17 and the tower body members 16, the turbine tower may be semi-conical or semi-tubular and have a flat face. It is to be understood that the tower base 17 and the tower body members 16 can be substantially identical to each other (e.g., having similar or identical material properties, shape, height, and/or weight). For example, the tower base 17 and each of the tower body members 16 can be constructed of steel and have a height of 20 feet. Alternatively, the tower base 17 and some (or all) of the tower body members 16 can differ from each other (e.g., having different material properties, shape, height, and/or weight). For example, the tower base 17 can be constructed of cement while some (or all) of the tower body members 16 are constructed of steel.

The tower base 17 includes a tower base guide rail 18a and a tower base rack 19a. The tower base rack 19a extends along the tower base guide rail 18a. Each of the tower body members includes a tower body guide rail 18b and a tower body rack 19b, with the tower body rack 19b extending along the tower body guide rail 18b. After the turbine tower 2 is formed (i.e., after at least one tower body member 16 is connected to the tower base 17), the tower base guide rail 18a and the tower body guide rails 18b collectively form a rail track 18. It is to be understood that as a vertical height of the turbine tower 2 is increased by adding additional tower body members 16, a length of the rail track 18 will also increase because of the additional tower body guide rails 18b. After the turbine tower 2 is formed (i.e., after at least one tower body member 16 is connected to the tower base 17), the tower base rack 19a and the tower body racks 19b collectively form a rack 19. It is to be understood that as a vertical height of the turbine tower 2 is increased by adding additional tower body members 16, a length of the rack 19 will also increase because of the additional tower body racks 19b.

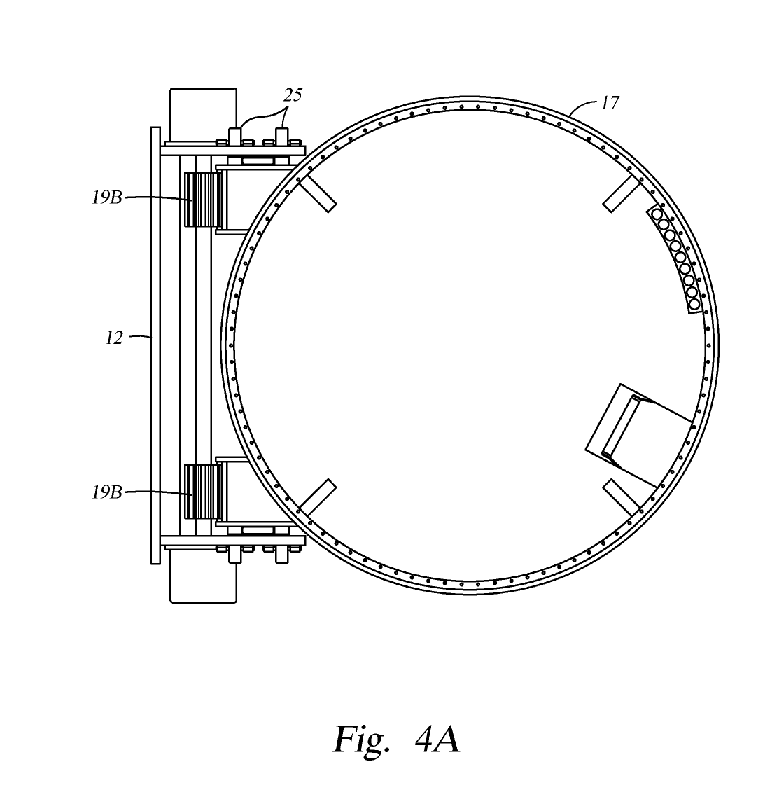

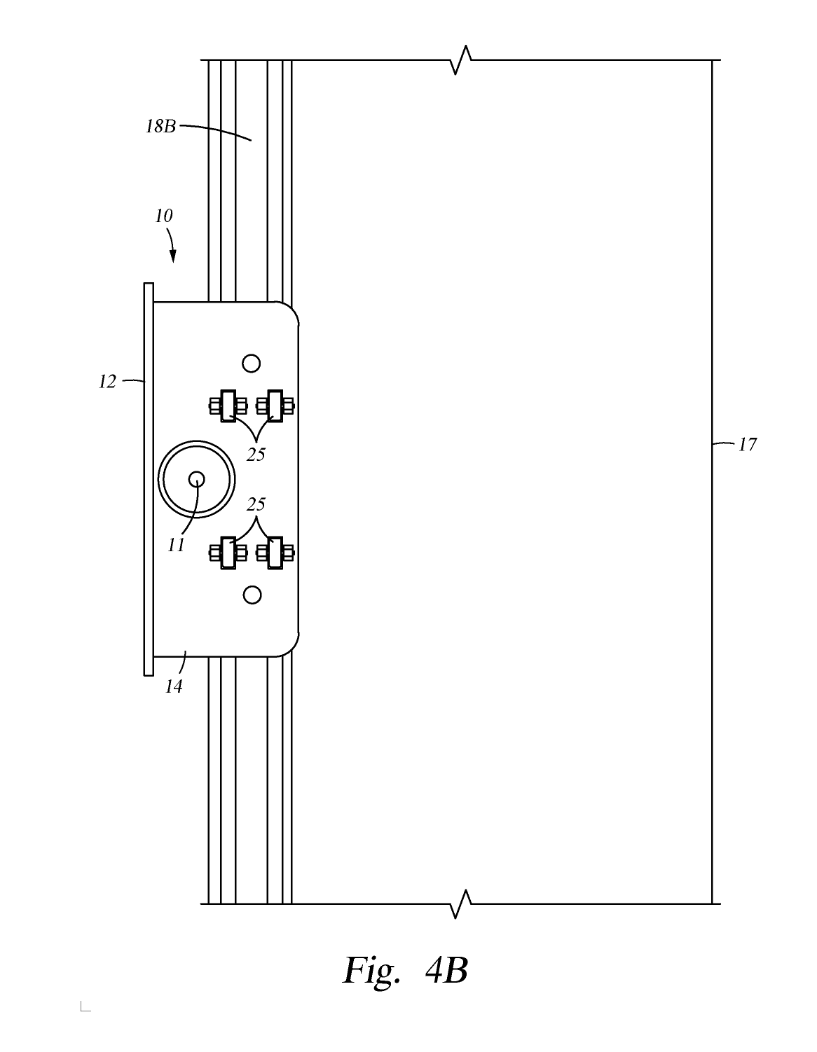

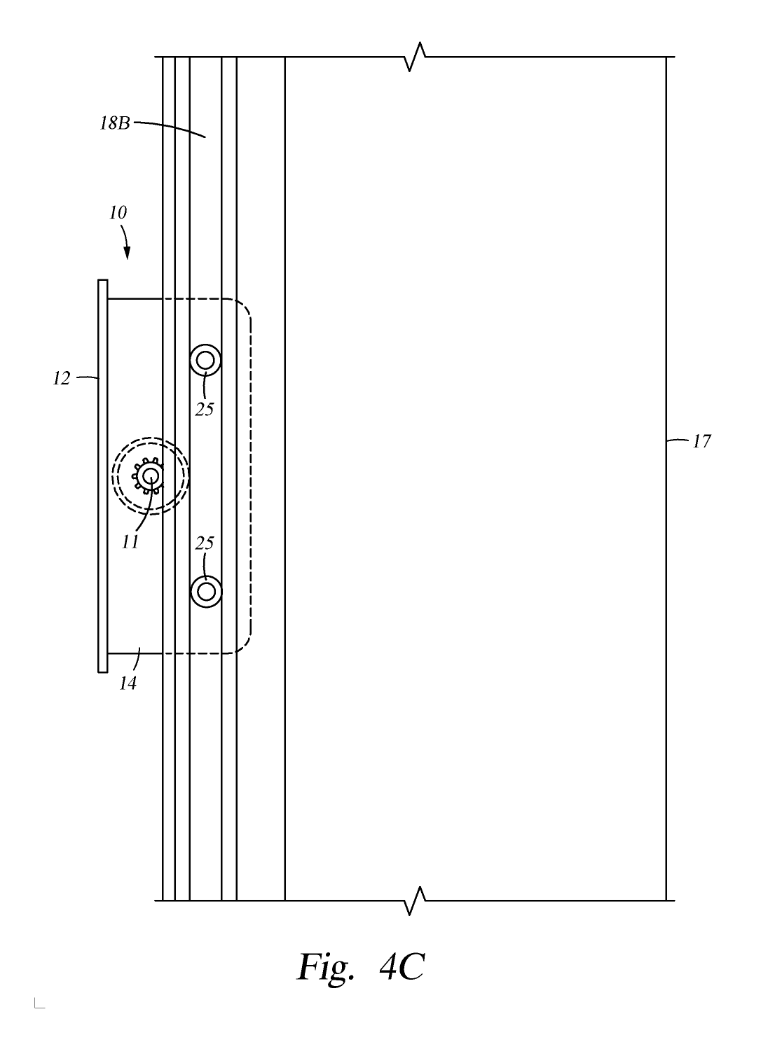

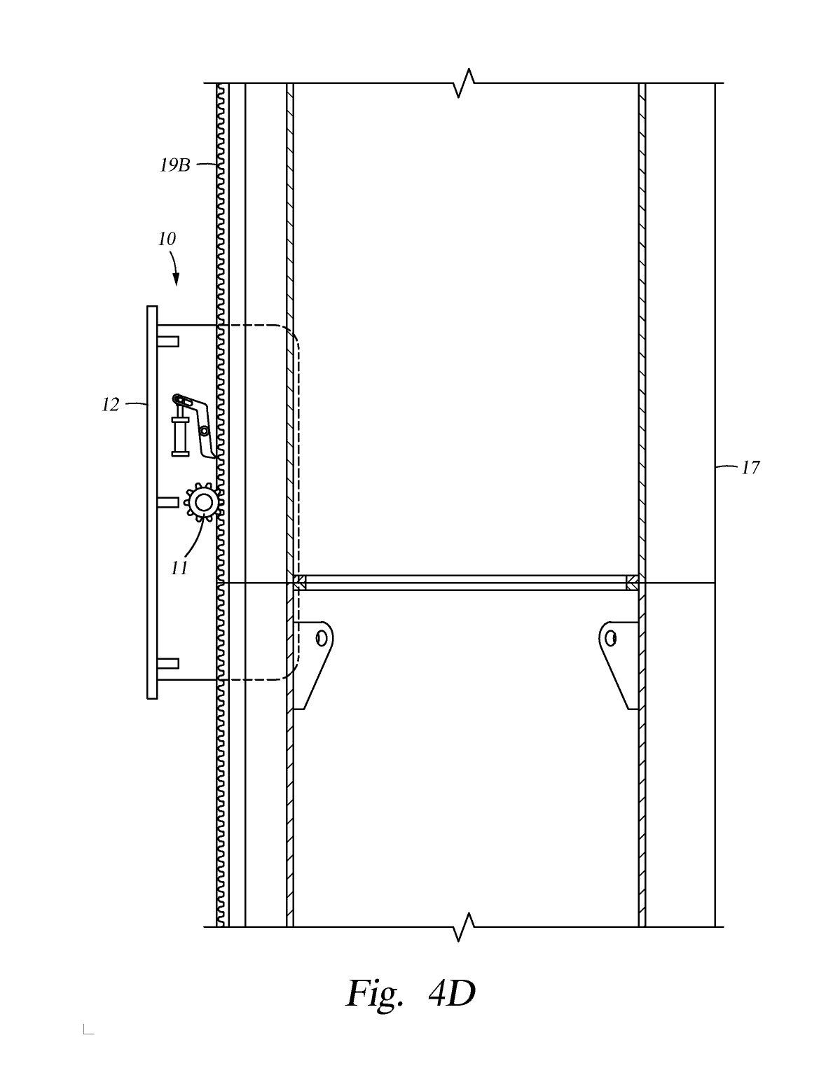

As illustrated in FIGS. 4A-4D, the carriage 10 may include a pinion 11, a bearing 12, and a body 14. The pinion 11 may be engageable with the rack 19 in a manner that facilities movement of the carriage 10 up the turbine tower 2. The bearing 12 may be attached to the body 14. Trolley wheels 25 may be disposed in and connected to the carriage body 14. The trolley wheels 25 may be part of a trolley that includes an actuator for selectively engaging the trolley wheels with the rail track 18. The bearing 12 may be adapted to either operatively connect the nacelle 6 to the carriage 10 or to operatively connect a crane platform 23 to the carriage. The bearing 12 may allow for rotation of the nacelle 6 relative to the body 14 subject to a rotary drive (not shown). The rotary drive may operated by a programmable logic controller (PLC, not shown) in order to point the nacelle 6 into the wind during operation of the wind turbine 1. The rotary drive may include an electric motor (not shown) connected to the carriage body 14 and rotationally connected to a pinion (not shown) which meshes with a gear (not shown) of the bearing 12. Operation of the rotary drive motor may rotate the nacelle 6 relative to the carriage body 14. The rotary drive may further include a lock (not shown) for selectively rotationally connecting the nacelle 6 relative to the carriage body 14. The lock may include a gear tooth (not shown) selectively engageable with the bearing gear via operation of a linear actuator (e.g., a solenoid) and a proximity or limit sensor to verify engagement of the tooth with the gear. Engagement of the gear with the tooth may rotationally connect the nacelle 6 to the carriage body 14. Verification of engagement by the proximity/limit sensor may also prevent operation of the rotary drive motor when the rotary drive is locked. Alternatively, the lock may include a disk (not shown) incorporated in the rotary drive motor and a retainer for retaining the disk.

Collectively, the rail track 18 and the trolley wheels 25 may constitute a guide system. The rail track 18, which includes the tower base guide rail 18a and the tower body guide rails 18b, may be connected to a flat face of the tower base 17 and the tower body members 16, respectively, such as by fastening or welding. It is to be understood that additional known methods could be used to connect the tower base guide rail 18a and the tower body guide rails 18b to the tower base 17 and the tower body members 16, respectively. When engaged with the rail track 18, the trolley wheels 25 may operatively connect the carriage body 14 to the rail track 18 in a manner that enables longitudinal movement (e.g., upward and/or downward movement) of the carriage 10 relative to the turbine tower 2 subject to operation of a drive system.

Collectively, the pinion 11, the rack 19, and an electric drive motor (not shown) may constitute the drive system that, upon operation, facilitates movement of the carriage 10 up and down the turbine tower 2. A rotor of the drive motor (not shown) may be rotationally connected to pinion 11 and a housing of the drive motor (not shown) may be connected to the carriage body 14. The pinion 11 may be supported by the carriage body 14 so that the pinion may rotate relative thereto. Operation of the drive motor may lift the carriage 10 longitudinally upward along the turbine tower 2. For lowering the carriage 10, the drive motor may be speed controllable to manage descent. Additionally, the drive system may further include a lock to selectively longitudinally support the carriage 10 from the turbine tower 2. Alternatively, the drive system may further include a brake (not shown) to control descent of the carriage 10.

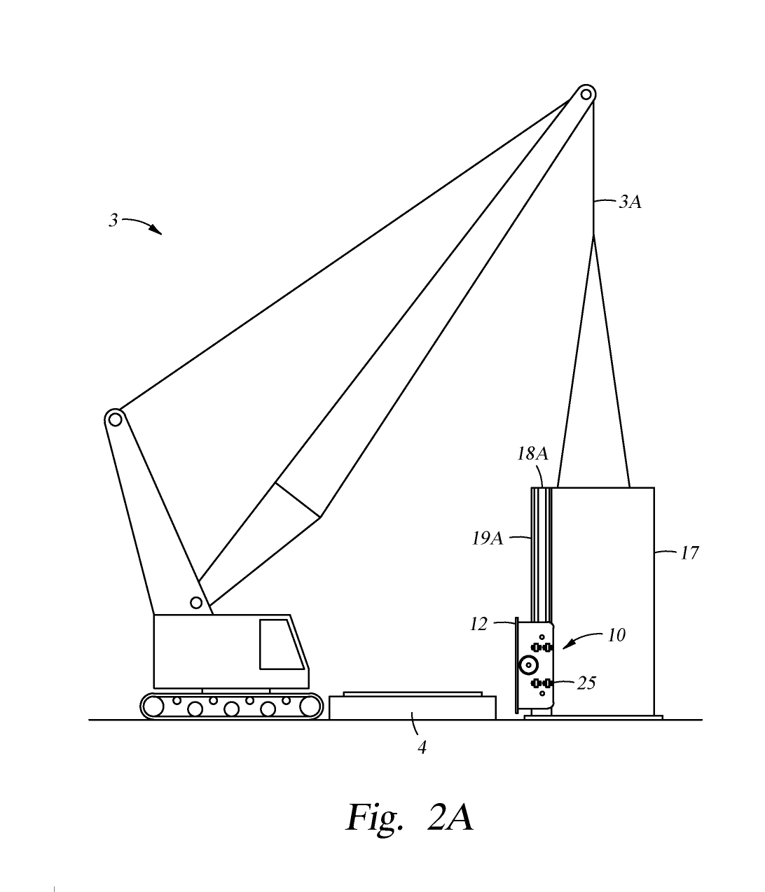

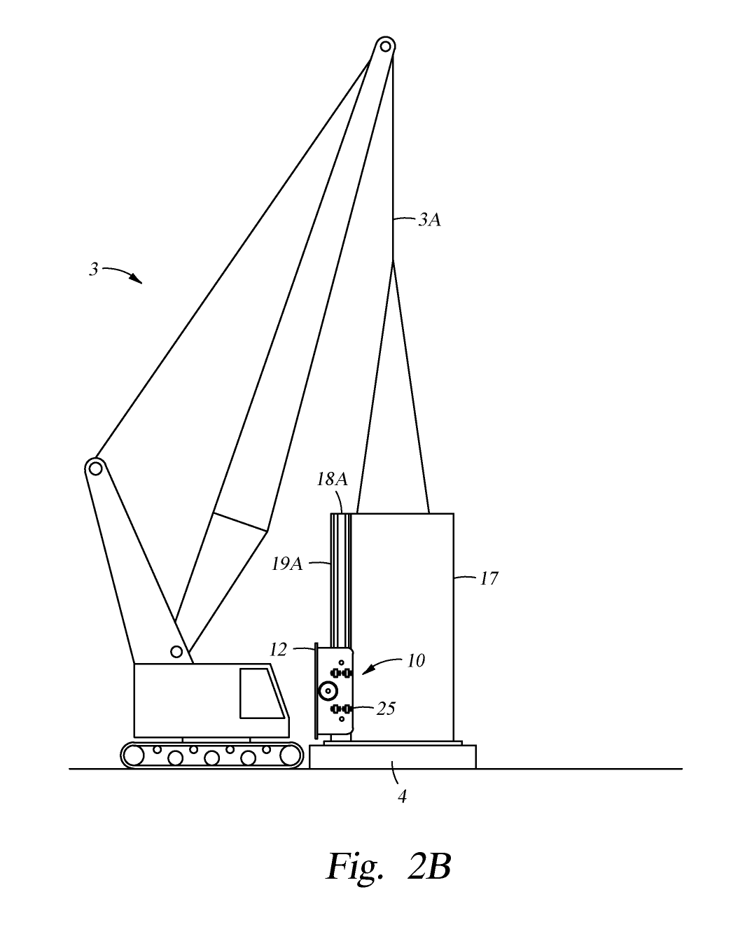

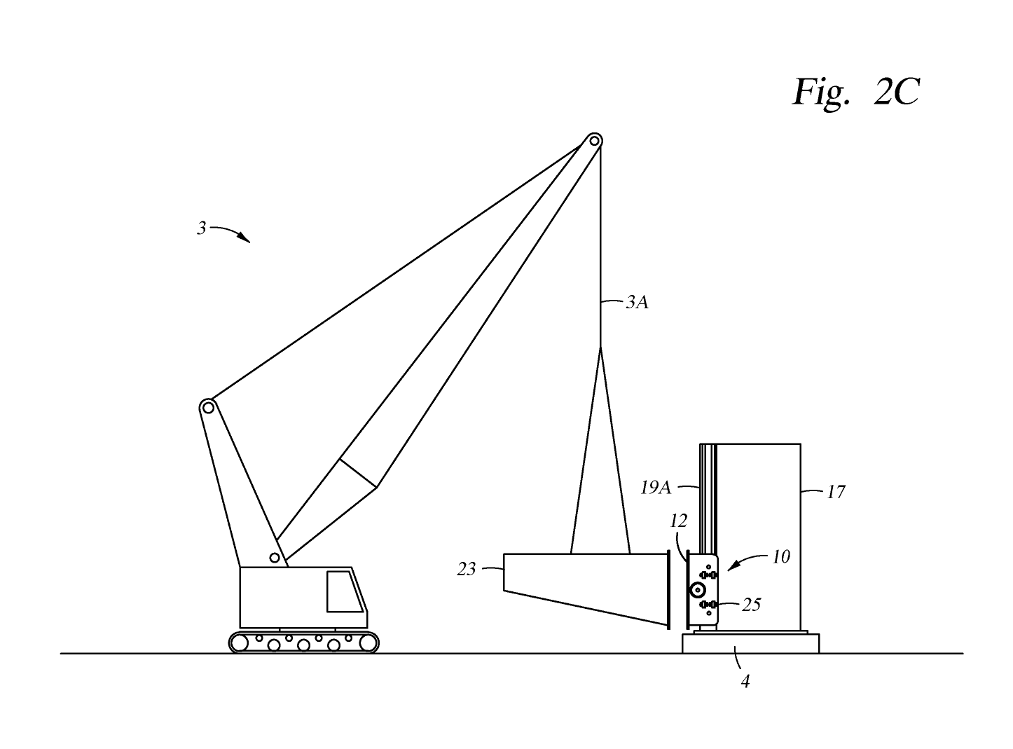

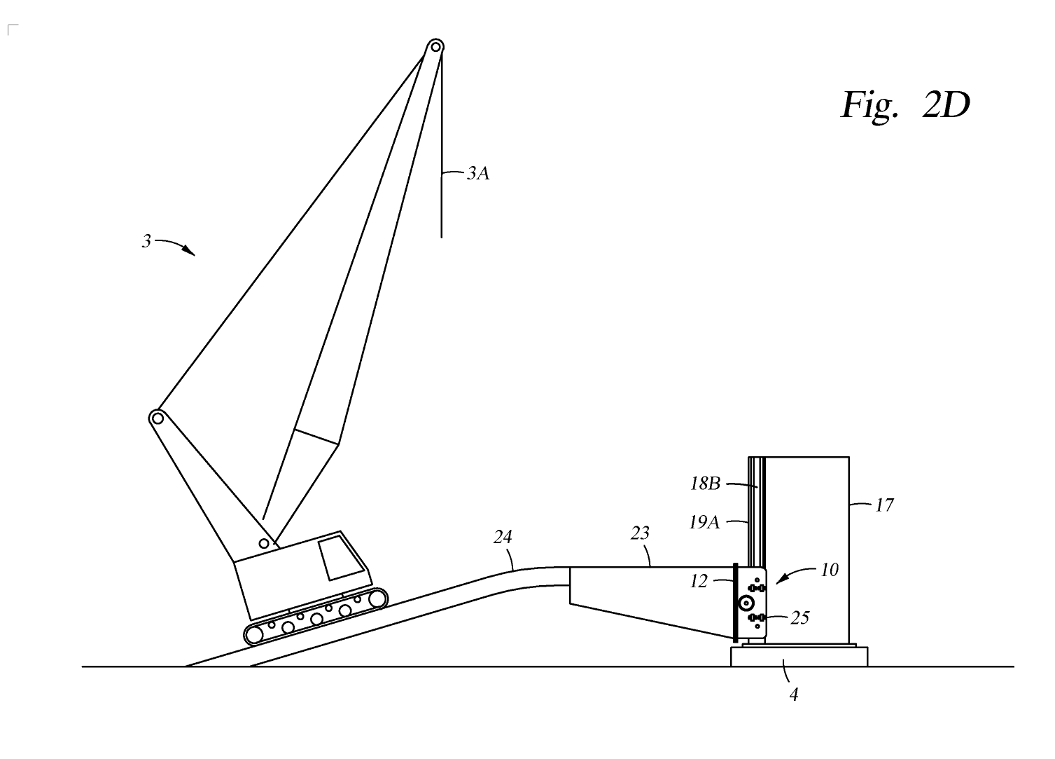

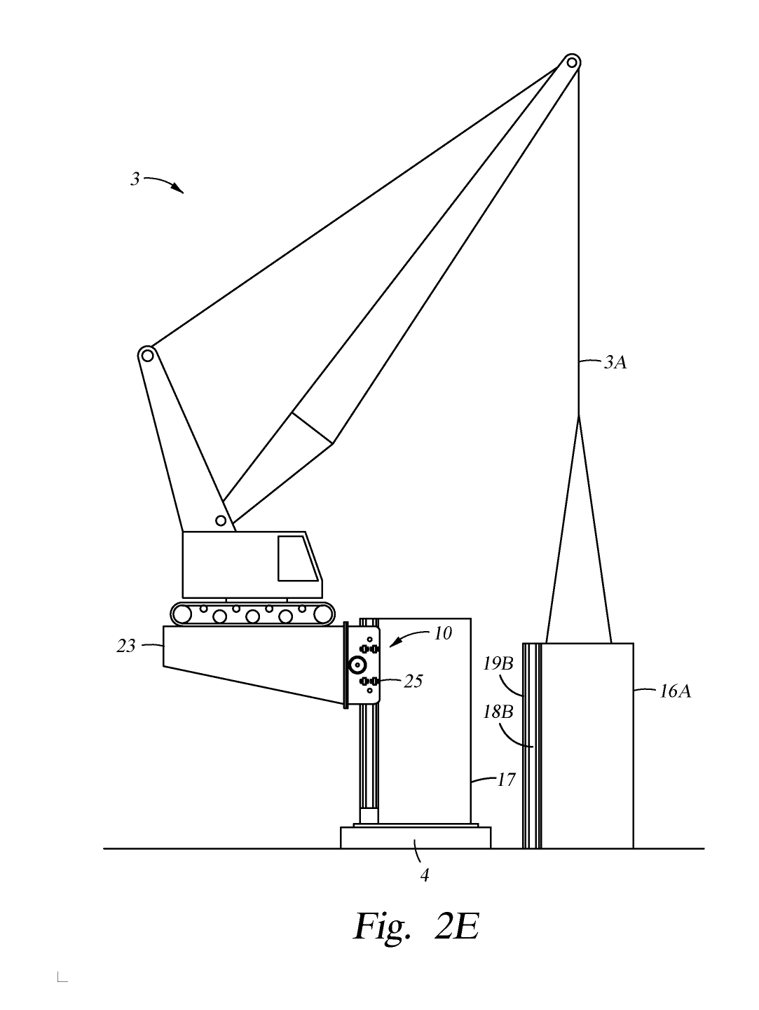

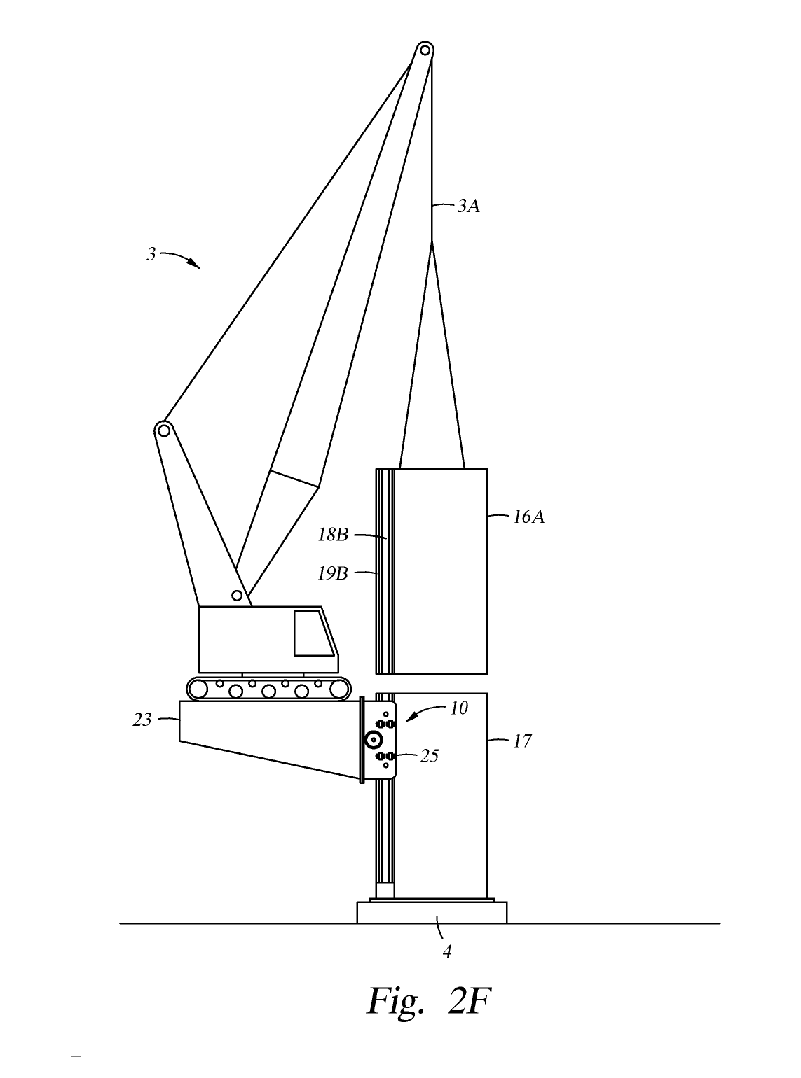

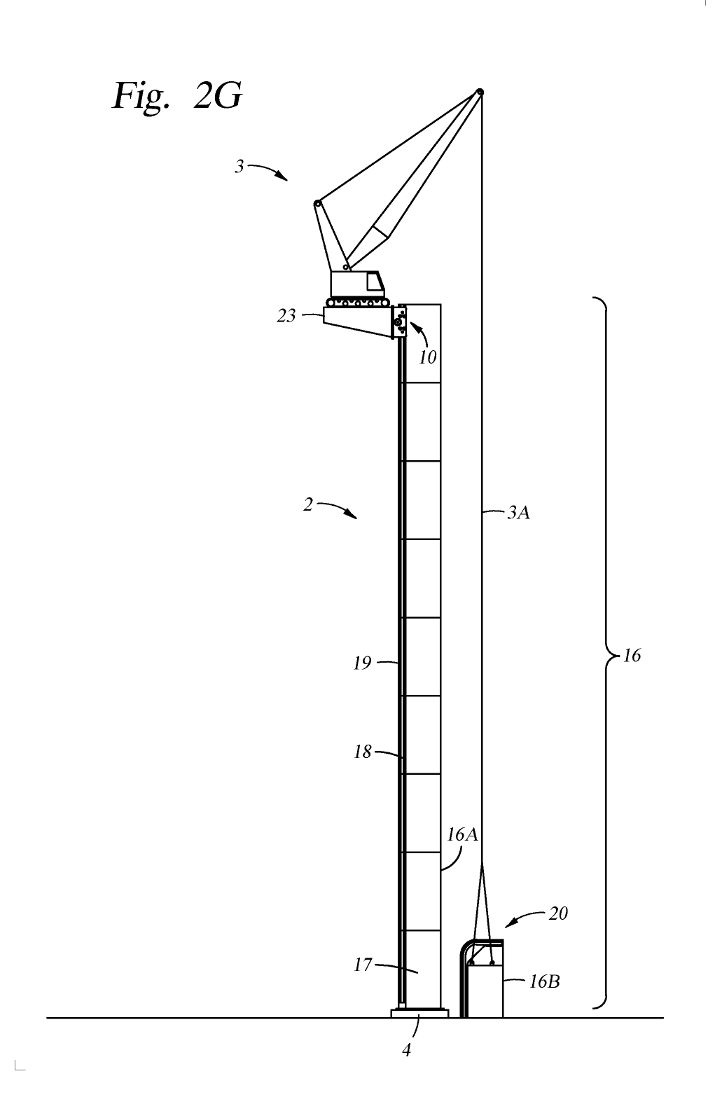

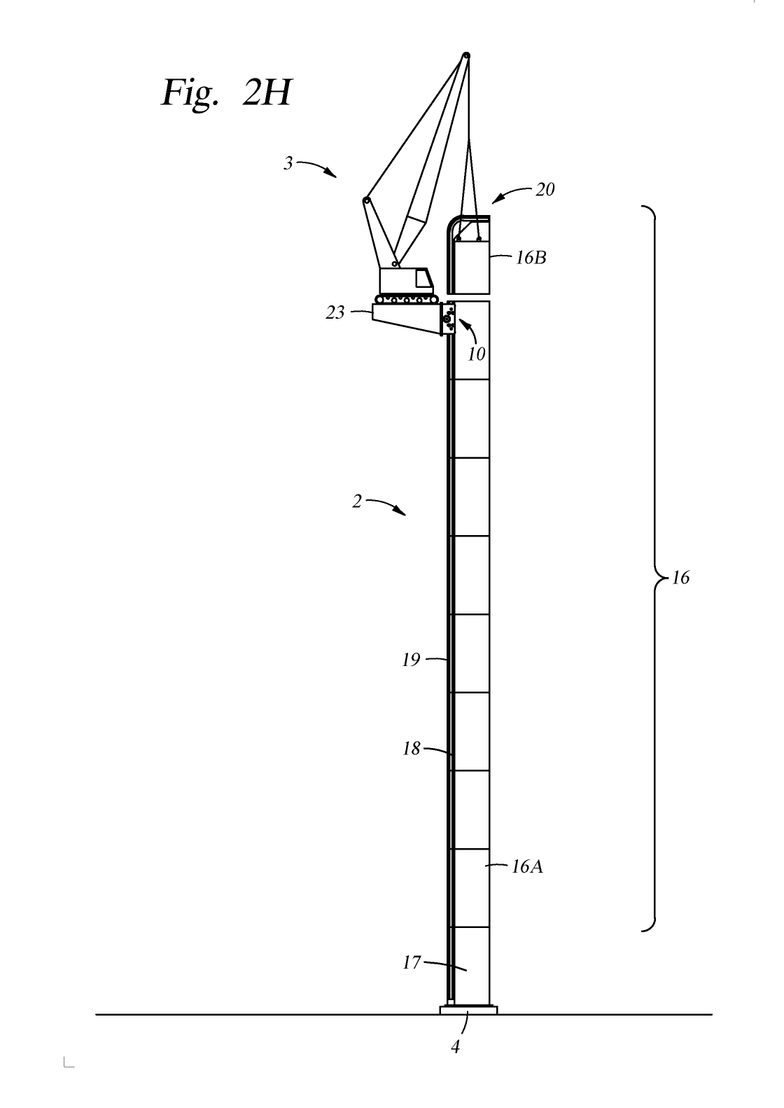

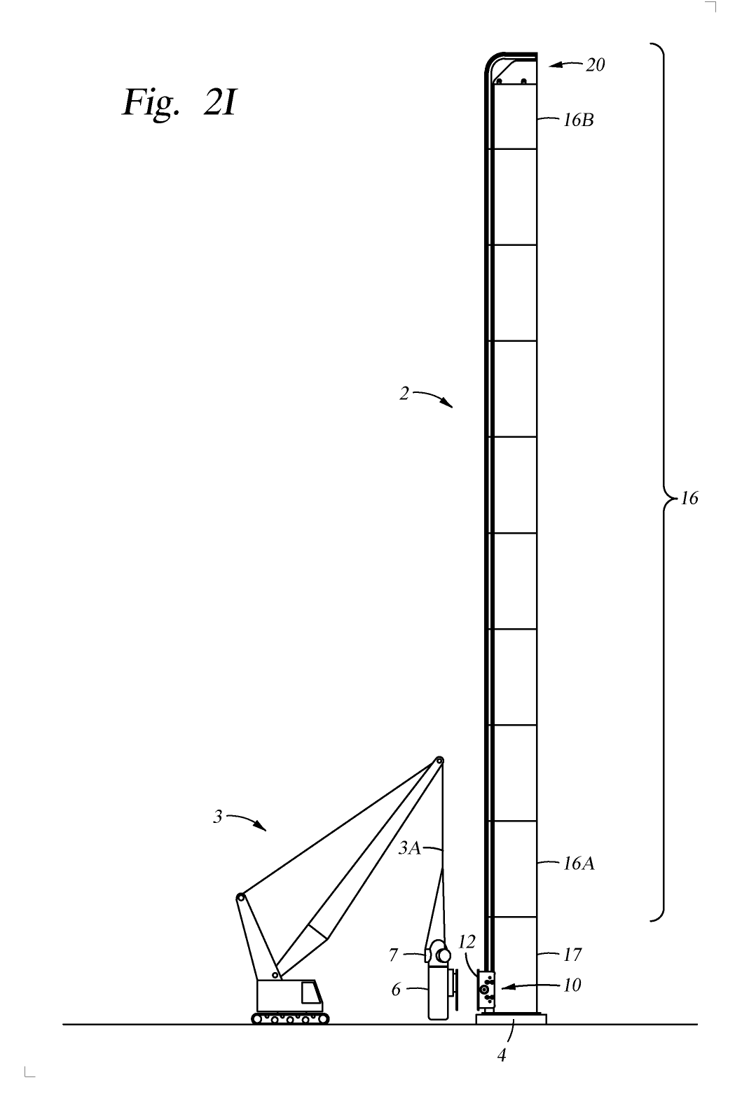

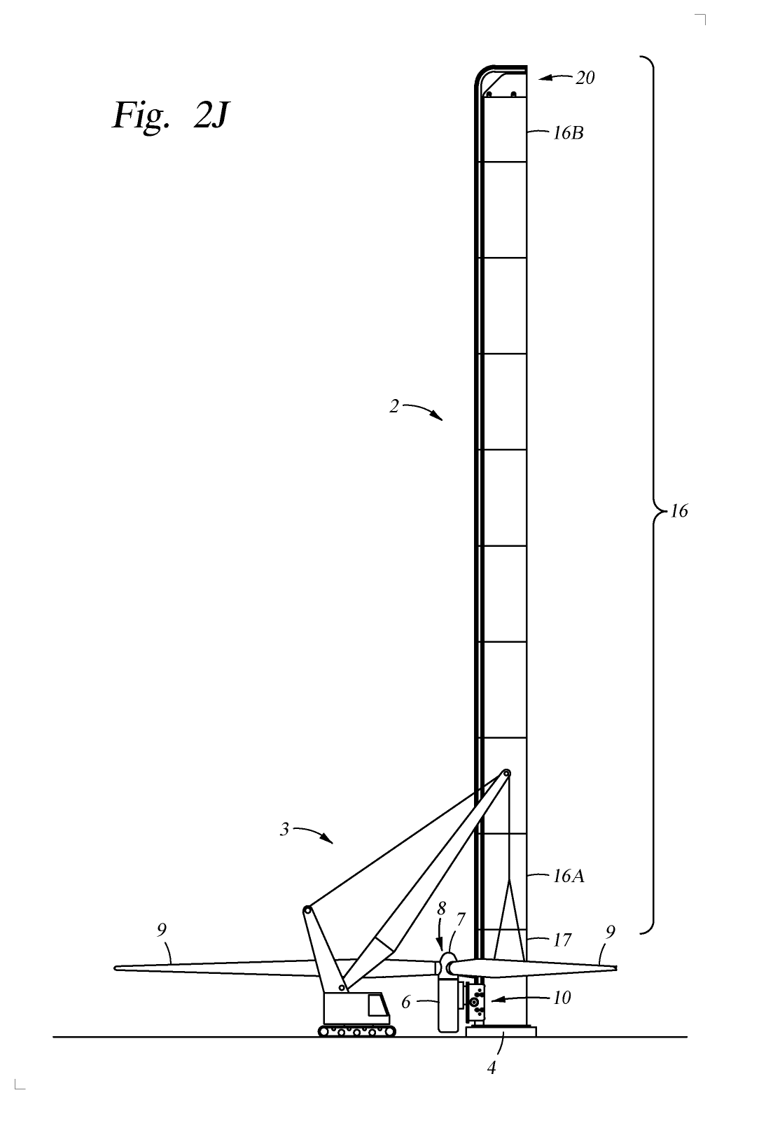

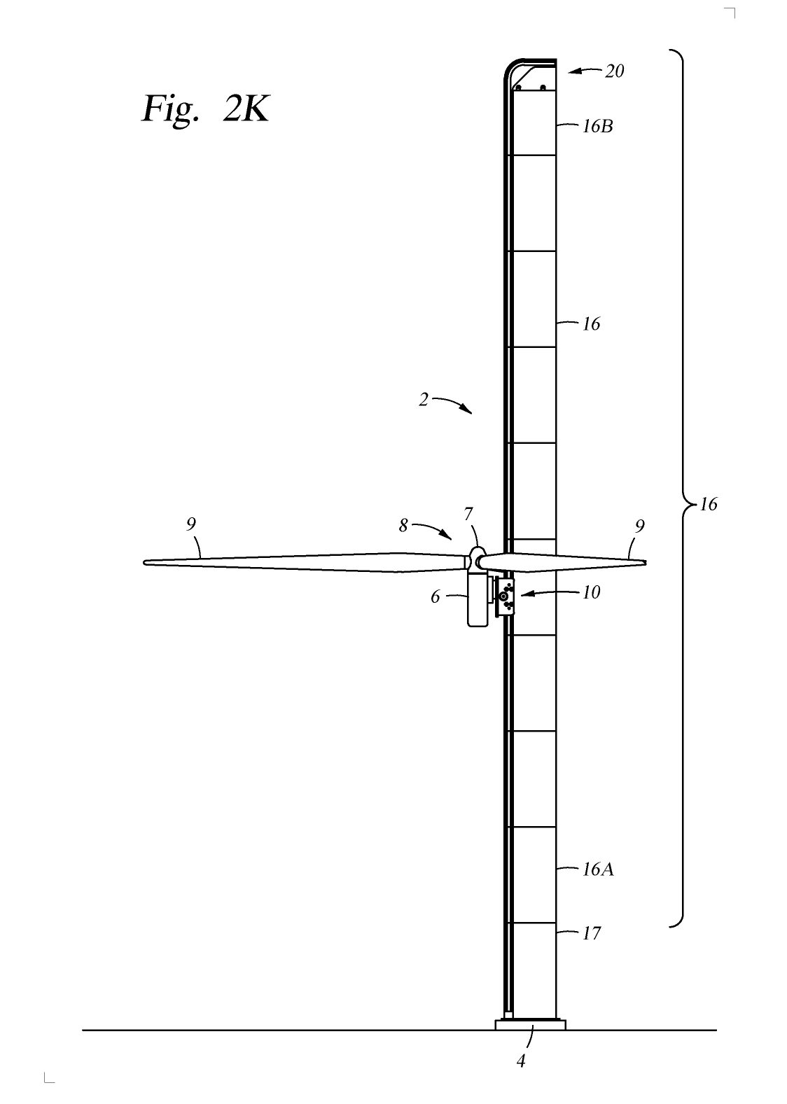

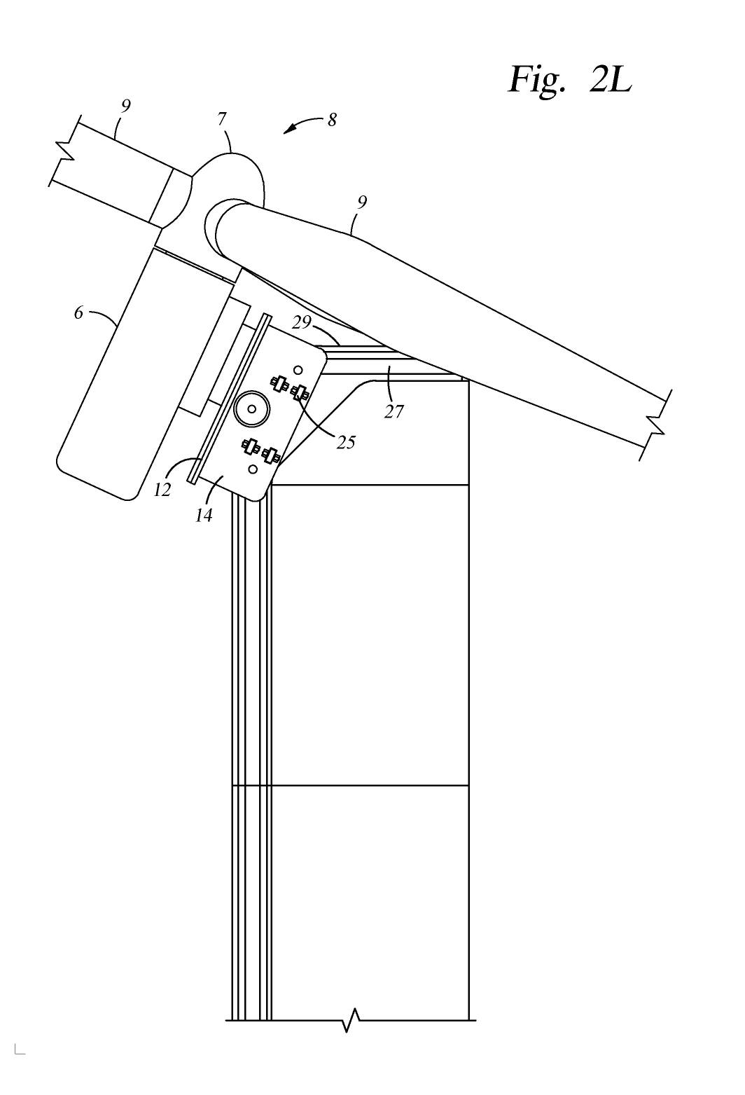

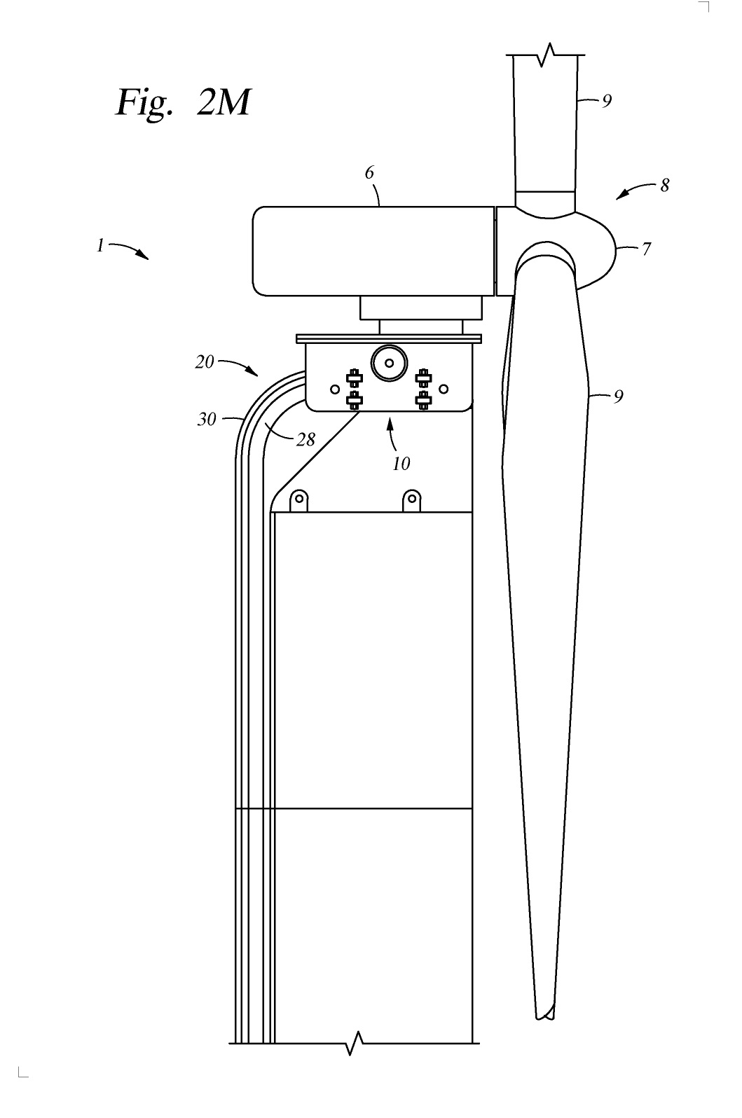

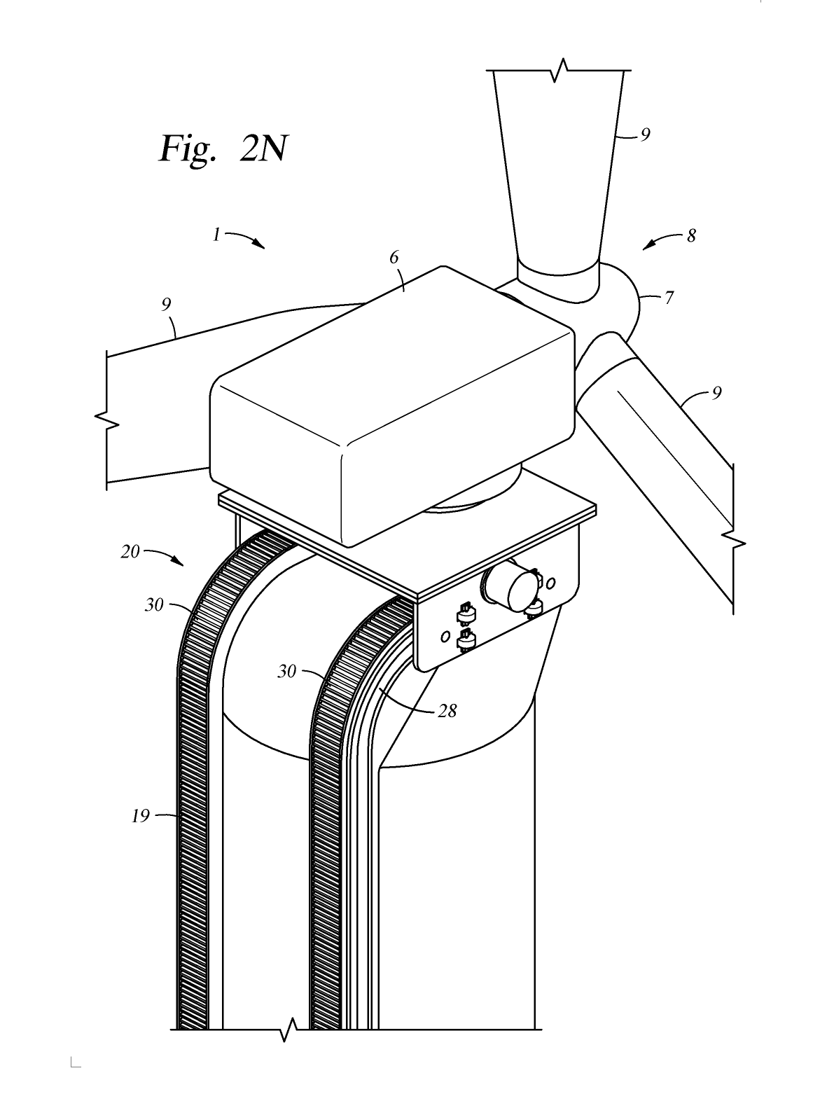

FIG. 2A illustrates a crane rope 3a of crawler crane 3 placing the tower base 17 in an upright position. As illustrated in FIG. 2B, the tower base 17 may be positioned on a pad 4. The pad 4 may be formed for receiving the tower base 17. It is to be understood that the crawler crane 3 may be a rough terrain or all terrain crane and/or include other boom types, such as lattice or A-frame. FIG. 2C illustrates the crawler crane 3 releasably connecting the crane platform 23 to the carriage 10. The crane platform 23 is a platform of a sufficient size to enable a crane to be located thereon. The crane that is positioned onto the crane platform 23 may be the crawler crane 3. Alternatively, a crane other than crawler crane 3 could be positioned onto the crane platform 23. As illustrated in FIG. 2D, the crawler crane 3 may be positioned onto the crane platform 23 by attaching a ramp 24 to the crane platform. After attaching ramp 24 to the crane platform 23, the crawler crane 3 can be positioned onto the crane platform by driving the crawler crane up the ramp and onto the crane platform.

As illustrated in FIG. 2E, the carriage 10 and the crane platform 23 may be raised by the drive system to a top of the tower base 17 along the tower base guide rail 18a. The crane rope 3a of crawler crane 3 is connected to a first tower body member 16a. The crawler crane 3 is counterbalanced in a manner that enables the crane to lift the first tower body member 16a without toppling over or otherwise falling from crane platform 23. As illustrated in FIG. 2F, the first tower body member 16a is being connected to the tower base 17 by the crawler crane 3, thereby forming turbine tower 2. The first tower body member 16a is connected to the tower base 17 in a manner such that the tower base guide rail 18a and the tower body guide rail 18b are aligned and the tower base rail 19a and the tower body rack 19b are aligned, enabling the carriage 10 to move from the tower base 17 to the first tower body member 16a and vice versa. The first tower body member 16a may be connected to the tower base 17 using fasteners (not shown). Alternatively, the first tower body member 16a may be connected to the tower base 17 using any other attachment means known to a person of ordinary skill in the art. A similar process is then repeated to connect additional body members 16 to the turbine tower 2, thereby increasing a vertical height of the turbine tower. Every time an additional body member 16 is being prepared to be connected to the existing turbine tower 2, the crane platform 23 may be raised to a top of the existing turbine tower along the rail track 18 before attaching the additional body member. Alternatively, in some situations, the crane platform 23 may only be raised to a top of the existing turbine tower 2 along the rail track 18 after two or more additional body members 16 have been connected to the turbine tower. The additional tower body members 16 are connected to the first tower body member 16a and each other in a manner such that the tower base guide rail 18b and the tower body guide rails 18b are aligned and the tower base rack 19a and the tower body rack 19b are aligned, thereby enabling the carriage 10 to move between the tower base, the first tower member, and each of the additional tower body members. Each of the additional tower members 16 can be connected to each other or to the first tower body member 16a using fasteners (not shown) or any other attachment means known to a person of ordinary skill in the art.

FIG. 2G illustrates the crane platform 23 may be raised to a top of the turbine tower 2 along the rail track 18 before the crane rope 3a of crawler crane 3 is connected to a top tower body member 16b. The top tower body member 16b may include a pivot system 20. FIG. 2H illustrates the top tower body member 16b being connected to the existing turbine tower 2. The top tower body member 16b is connected to a top body member of the existing turbine tower 2 in a manner such that the tower body guide rail 18b of the top tower body member 16b aligns with the rail track 18 of the existing turbine tower and the tower body rack 19b aligns with the rack 19 of the existing turbine tower, thereby enabling the carriage to move between the existing turbine tower and the top tower body member. The top tower body member 16b may be connected to a top tower body member of the existing turbine tower 2 using fasteners (not shown) or any other attachment means known to a person of ordinary skill in the art.

It is to be understood that during assembly of the turbine tower 2, the crane rope 3a of the crawler crane 3 may connect to the tower base 17 or to any of the individual tower body members 16 in any manner recognized by a person of ordinary skill in the art. By assembling the turbine tower 2 using the method described in the previous paragraphs, crawler crane 3 only has to have the capability to lift a single member of the turbine tower 2 at a time (e.g. tower base 17 or tower body member 16). Moreover, crawler crane 3 does not need to lift nacelle 6 and hub 7 to a top of the turbine tower 2 after the turbine tower has been assembled. Consequently, the size and cost of the crane needed to assemble turbine tower 2 can be reduced.

After the top tower body member 16b is connected, the crane platform 23 and the crawler crane 3 located thereon may be lowered along the rail track 18 by the drive system of the carriage 10. Upon reaching a bottom of the tower base 17, the ramp 24 may be reattached to the crane platform 23, thereby enabling the crawler crane 3 to be removed from the crane platform. The ramp 24 may then be detached from the crane platform 23 and the crane platform 23 subsequently removed from the carriage 10. As illustrated in FIG. 2I, the nacelle 6 and hub 7 may then be connected to the carriage 10, such as by a flanged connection on the bearing 12. The nacelle 6 and hub 7 may be connected to the carriage 10 in the vertical position by crawler crane 3. The hub 7 may point upward (shown) or downward (not shown) in the vertical position. The bearing 12 may connect the nacelle 6 to the carriage body 14 and allow for rotation of the nacelle 6 relative to the body subject to a rotary drive (not shown). The rotary drive may operated by a programmable logic controller PLC (not shown) in order to point the nacelle 6 into the wind during operation. The rotary drive may include an electric motor (not shown) connected to the carriage body and rotationally connected to a pinion (not shown) which meshes with a gear (not shown) of the bearing 12. Operation of the rotary drive motor may rotate the nacelle 6 relative to the carriage body 14. The rotary drive may further include a lock (not shown) for selectively rotationally connecting the nacelle relative to the carriage body. The lock may include a gear tooth (not shown) selectively engageable with the bearing gear via operation of a linear actuator (i.e., a solenoid) and a proximity or limit sensor to verify engagement of the tooth with the gear. Engagement of the gear with the tooth may rotationally connect the nacelle 6 to the carriage body 14. Verification of engagement by the proximity/limit sensor may also prevent operation of the rotary drive motor when the rotary drive is locked. Alternatively, the lock may include a disk (not shown) incorporated in the rotary drive motor and a retainer for retaining the disk.

FIG. 2J illustrates blades 9 may be attached to hub 7 to thereby form the rotor 8. After the nacelle 6 and the hub 7 are connected to the carriage 10 and the rotor 8 formed, the drive system in combination with the guide system of the carriage may be used to raise the nacelle and rotor upwardly along the rail track 18. FIG. 2K illustrates the nacelle 6 and hub 7 being raised by the carriage 10 along the rail track 18 at a location approximately half of the vertical height of turbine tower 2. FIG. 2L illustrates the nacelle 6 and hub 7 beginning to pivot from the vertical position to a horizontal position via pivot system 20 of the top tower body member 16b. The pivot system 20 may include a horizontal guide track 27, a curved guide track 28, a horizontal rack 29, and a curved rack 30. The horizontal guide track 27 may be connected to rail track 18 via the curved guide track 28. The horizontal rack 29 may be connected to rack 19 via the curved rack 30. Upon reaching the curved guide track 28 and the curved rack 30, the electric drive motor (not shown) enables the carriage 10, which is currently in a vertical position, to move seamlessly from rack 19 to curved rack 30 along rail track 18 and curved guide track 28. The electric drive motor (not shown) may continue to propel the carriage 10 forward on the curved rack 30 along curved guide track 28 until carriage seamlessly moves to horizontal rack 29 along horizontal guide track 27. In this manner, the pivot system 20 may collectively pivot the carriage 10, the nacelle 6, and the hub 7 from the vertical position to the horizontal position. FIGS. 2M and 2N illustrate the nacelle 6 and rotor 8 in the horizontal position and the wind turbine 1 ready for operation.

An alternative pivot system may include a stop (not shown) having a proximity or limit sensor (not shown) in communication with the PLC disposed in the turbine tower 2. In response to detection of the carriage 10, the nacelle 6, and the rotor 8 at the top of the turbine tower 2, the PLC may lock the drive motor of the carriage and engage pivot fasteners (not shown) with corresponding holes (not shown) formed in the carriage body 14 and the rail track 18, respectively, thereby pivoting the carriage body 14 to the rail track 18. The pivot fasteners may each be engaged and retracted by a fastener actuator (not shown), such as a solenoid and spring. Each pivot actuator may include a proximity or limit sensor in communication with the PLC to verify engagement of the pivot fasteners with the carriage body holes. Once the PLC has verified engagement, the PLC may deactivate the driver motor and disengage the trolley wheels 25 from the rail track 18. The alternative pivot system may further include a linear actuator (not shown), such as an electric motor and lead screw, disposed in a top of the turbine tower 2. An end of the lead screw distal from the motor may have a clamp and a clamp actuator in communication with the PLC via flexible leads. The PLC may then operate the clamp actuator to engage a pivot rod or pin (not shown) connected to the carriage body 14, thereby also pivoting the linear actuator to the carriage body. Once connected, the linear actuator may be operated to contract the lead screw, thereby pivoting the carriage 10, the nacelle 6, and the rotor 8 from the vertical position to the horizontal position. As the carriage 10, the nacelle 6, and the rotor 8 is pivoted, a tipping point may be reached. The linear actuator may be speed controlled to manage pivoting of the head after the tipping point is reached. Alternatively, a damper (not shown) may also be employed to control pivoting after carriage 10, the nacelle 6, and the rotor 8 tip from the vertical position to the horizontal position. Once the carriage 10, the nacelle 6, and the rotor 8 has been pivoted to the horizontal position, the linear actuator may be locked. A power cable (not shown) may be connected from a power converter (not shown) located in the turbine tower 2 and connected to the utility grid and the generator (not shown) of the nacelle 6. The PLC may also be connected to various sensors and actuators of the nacelle 6 and the rotary drive of the carriage via a third power and data cable. Alternatively, the nacelle may have its own programmable logic controller and the PLC may be connected to the nacelle's programmable logic controller. Alternatively, one or more of the pivot system actuators may be omitted and the functions performed manually.

Should the nacelle 6, hub 7, and/or rotor 8 need to be serviced, the drive system of the carriage 10 may be employed in a reverse operation. The reverse operation of the drive system would enable the carriage 10, the nacelle 6, and the rotor 8 to be pivoted from the horizontal position to the vertical position via the pivot system 20. The drive system could then be used to lower the carriage 10, the nacelle 6, and the rotor 8 to a base of the turbine tower 2. The nacelle 6 and/or hub/rotor 7, 8 may then be serviced at the base of the turbine tower 2 or removed and delivered to a service facility. Additionally, if severe weather, such as a hurricane, is forecast, the nacelle 6, the hub 7, and/or rotor 8 could be lowered to the base of the turbine tower 2 using the carriage 10 to offer more protection to these components of the wind turbine 1.

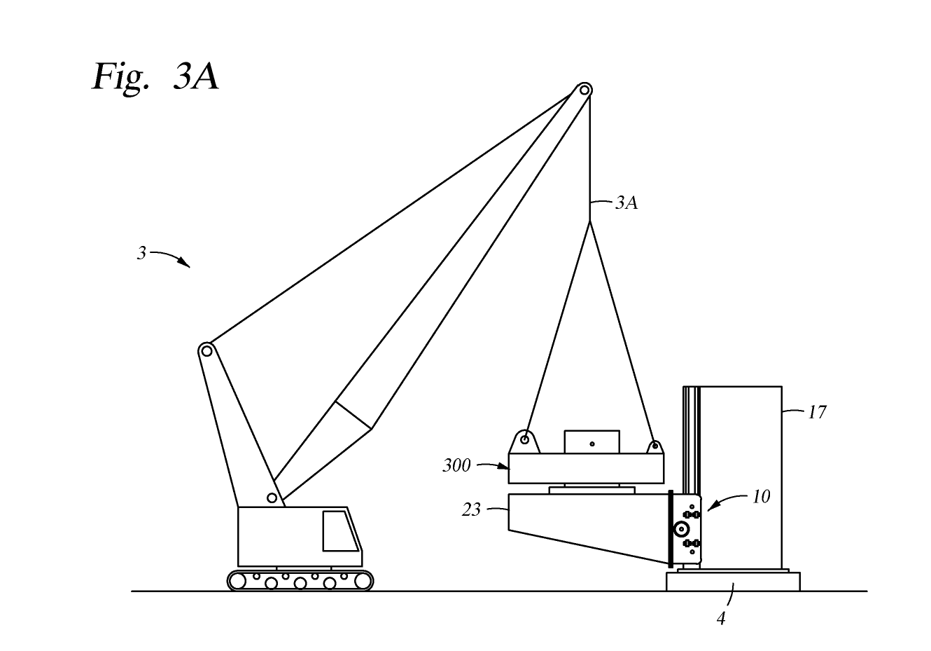

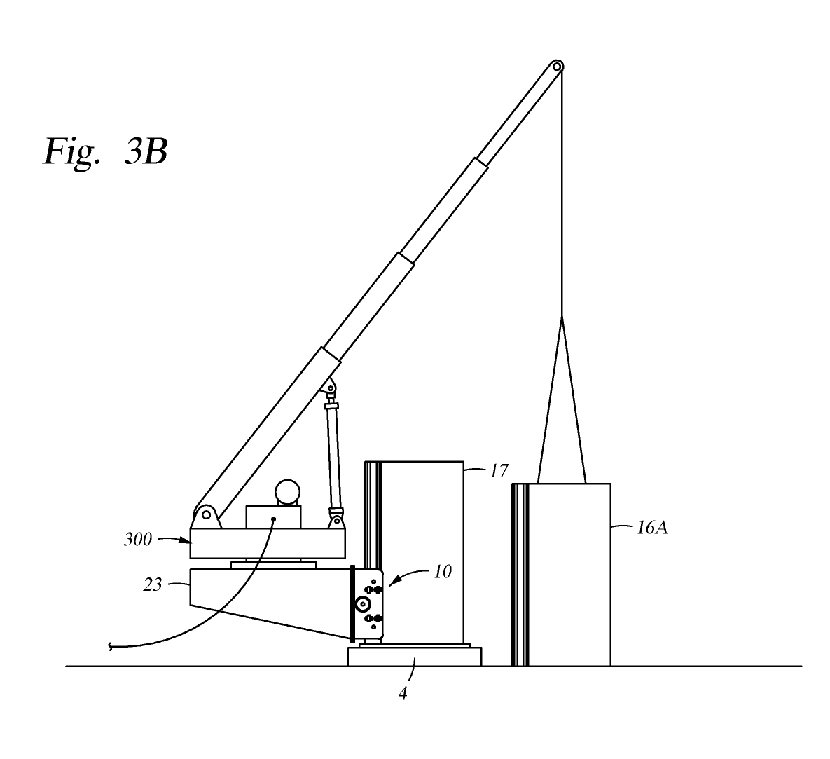

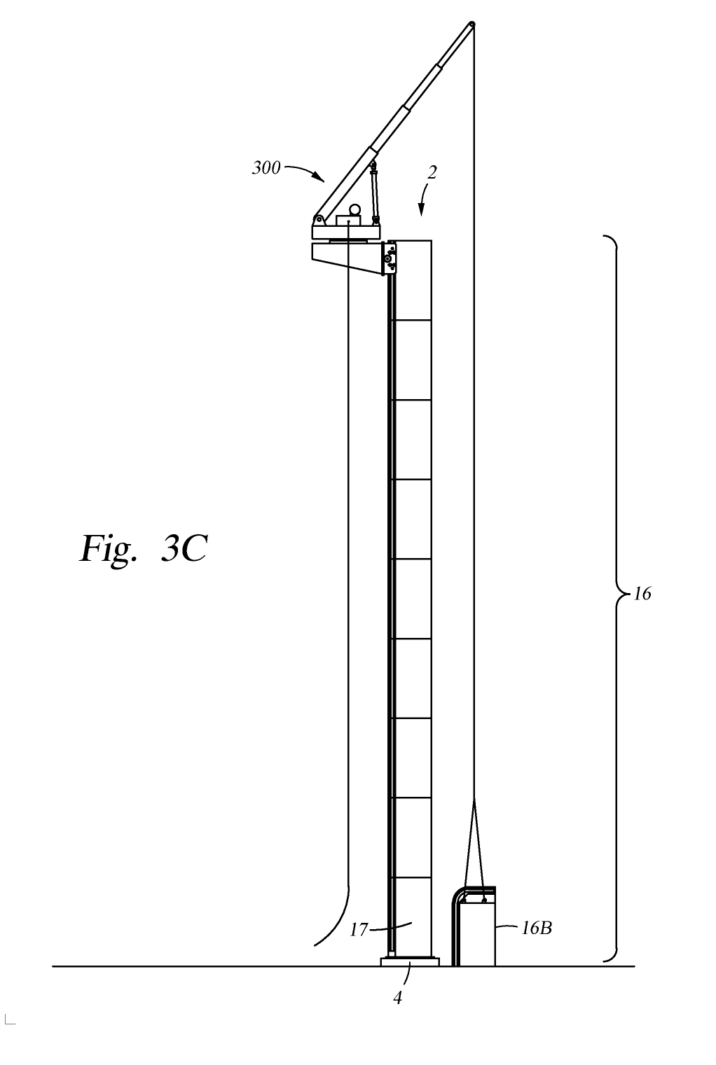

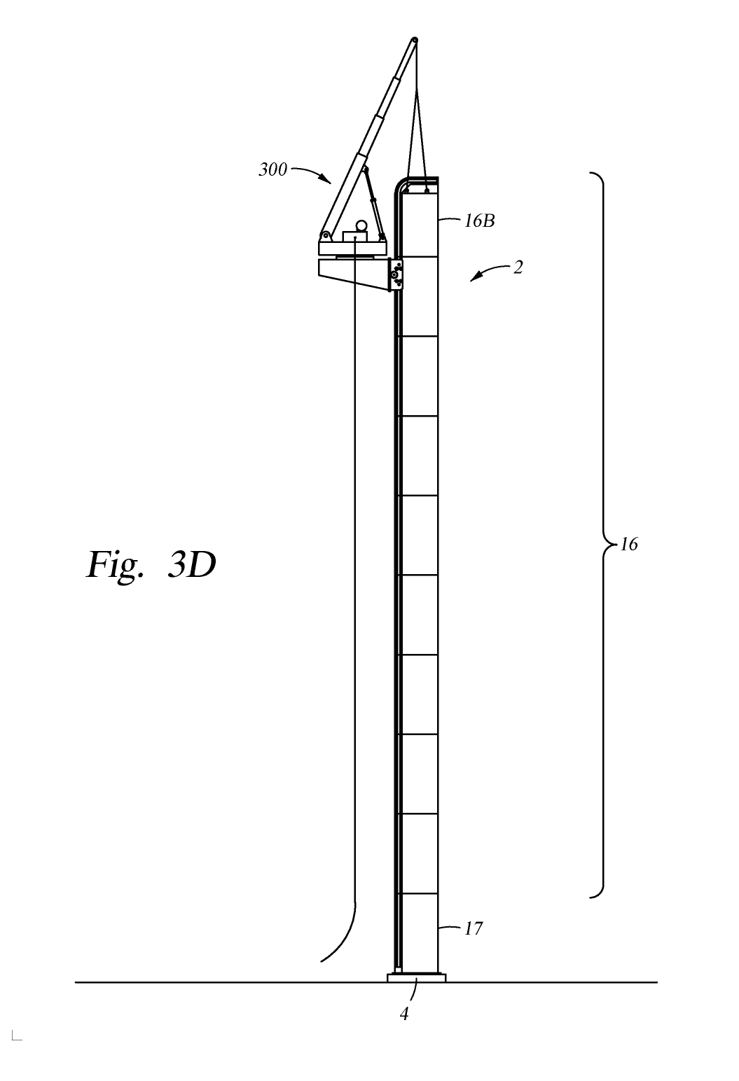

FIGS. 3A-3D illustrate a method of assembling tower turbine 2 according to another embodiment of the present disclosure. Many of the elements associated with the embodiment illustrated in FIGS. 3A-3D are the same as the embodiment depicted in FIGS. 2A-2N and will not be repeated here. As illustrated in FIG. 3A, the crawler crane 3 is used to position a telescoping stiff-leg crane 300 onto the crane platform 23. The telescoping stiff-leg crane 300 may be operated by a user from a ground surface, eliminating the need for the user to be located on the crane platform 23 as it is raised along turbine tower 2. As illustrated in FIGS. 3B-3D, the telescoping stiff-leg crane 300 may be used to assemble the turbine tower 2 in a manner similar to using the crawler crane 3 positioned on the crane platform 23.

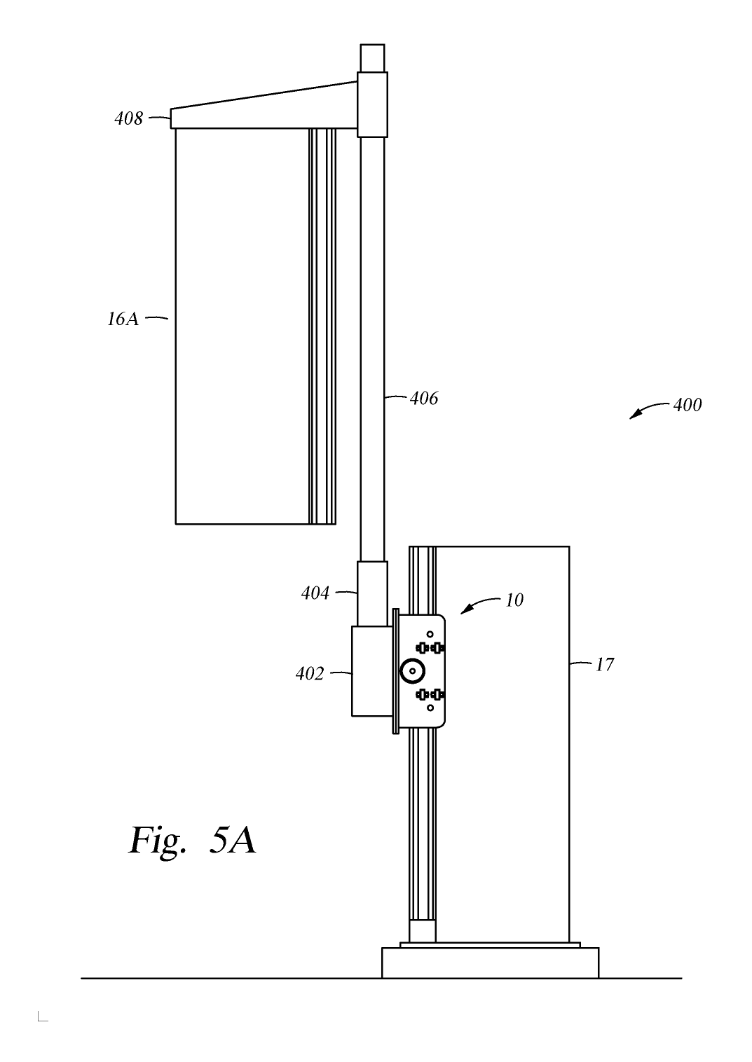

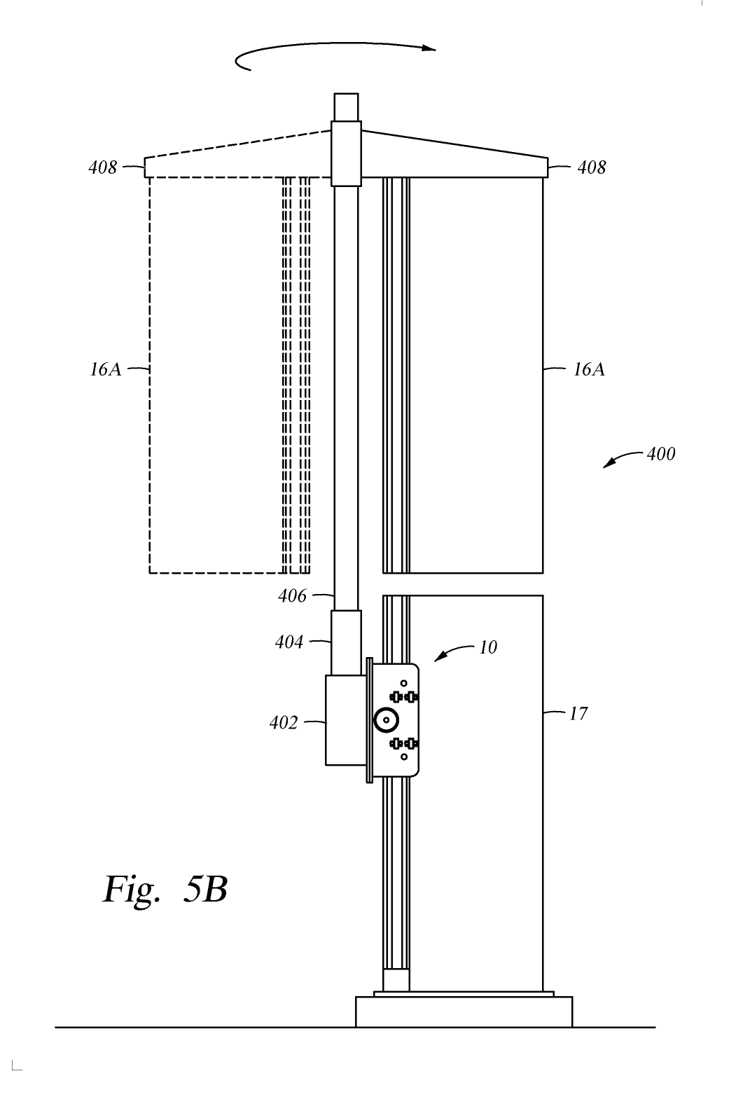

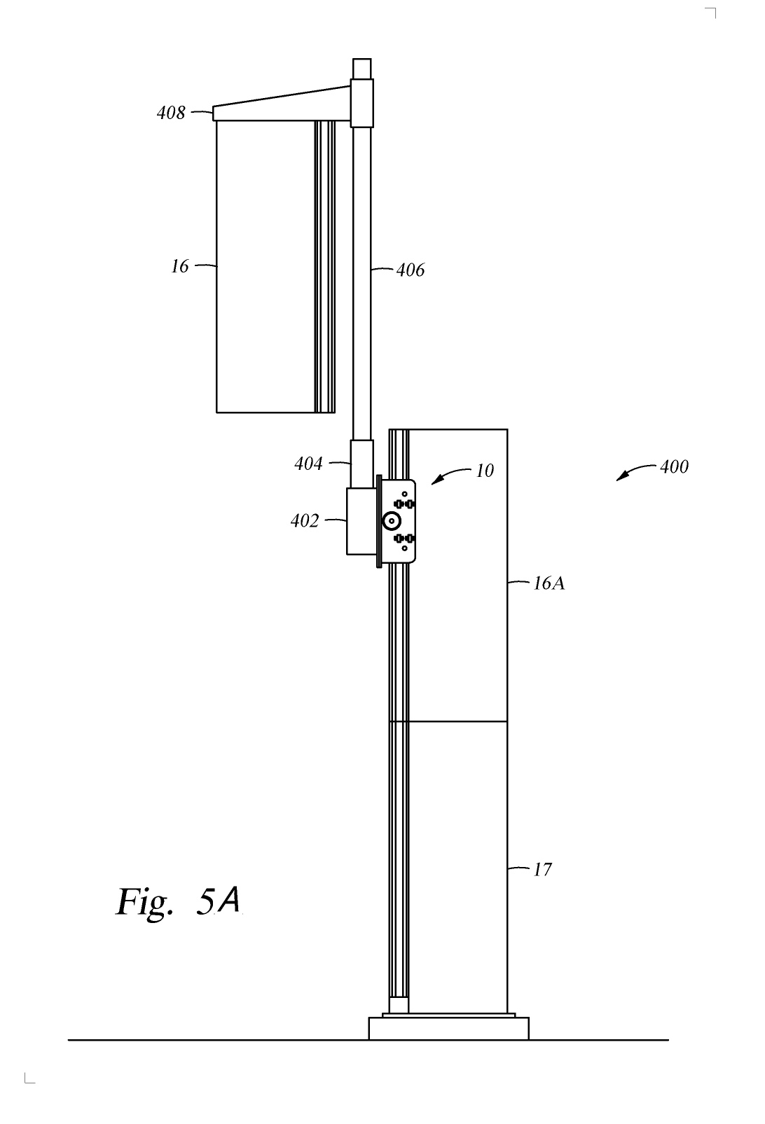

FIGS. 5A-5C illustrate yet another method of assembling tower turbine 2 according to another embodiment of the present disclosure. Many of the elements associated with the embodiment illustrated in FIGS. 5A-5C are the same as the embodiment depicted in FIGS. 2A-2N and will not be repeated here. The method illustrated in FIGS. 5A-5C eliminates the use of a crane attached to carriage 10. Instead, a rotating pole assembly 400 attached to carriage 10 may be used to assemble the turbine tower 2. The rotating pole assembly 400 may include a platform 402, a drive motor 404, a pole 406, and a support beam 408. The support beam 408 is attached to a top of the pole 406. A bottom of pole 406 is connected to the drive motor 404 such that upon operation of the drive motor 404, the pole 406 and the support beam 408 attached thereto rotate. In this manner, the rotating pole assembly 400 may be rotated from a loading position to an unloading position. Although FIG. 5B indicates the rotating pole assembly 400 is rotated from the loading position to the unloading position counter-clockwise, it is to be understood that the rotating pole assembly could be rotated clockwise The drive motor 404 may be attached to a platform 402, the platform being adapted to be connected to bearing 12 of the carriage 10.

A first tower body member 16a is stood upright on a ground surface and is attached to the support beam 408 using fasteners (not shown) while the rotating pole assembly 400 is in the loading position. It is to be understood that the first tower body member 16a may be connected to the support beam in other manners known to a person of ordinary skill in the art. The loading position is a position in which the support beam 408 is extending outwardly from the tower base 17 or the turbine tower 2, depending on the location of the carriage 10. When the rotating pole assembly 400 is in the loading position, a tower body member 16 can be connected to the support beam 408. As illustrated in FIG. 5A, after the first tower body member 16a is attached to the support beam 408, carriage 10 moves upwardly along the rail track 18 and the rack 19 while the rotating pole assembly 400 is in the loading position. After the carriage is located at a top of the tower base 17, the rotating pole assembly 400 is rotated via the drive motor 404 from the loading position to the unloading position (as illustrated in FIG. 5B). This results in the first tower body member 16a being positioned above the tower base 17. The first tower body member 16a may then be connected to the tower base 17 while the rotating pole assembly 400 is in the unloading position. The first tower body member 16a is connected to the tower base 17 in a manner such that the tower base guide rail 18a and the tower body guide rail 18b are aligned and the tower base rail 19a and the tower body rack 19b are aligned, enabling the carriage 10 to freely move from the tower base 17 to the first tower body member 16a and vice versa. The first tower body member 16a may be connected to the tower base 17 using fasteners (not shown). Alternatively, the first tower body member 16a may be connected to the tower base 17 using any other attachment means known to a person of ordinary skill in the art. After the first tower body member 16a is connected to the tower base 17, the first tower body is disconnected from the support beam 408 of the rotating pole assembly 400. The rotating pole assembly 400 may then be rotated from the unloading position to the loading position before the carriage 10 is lowered along the rail track and rack of the turbine tower 2. After the carriage 10 is lowered, an additional tower body member 16 stood upright on a ground surface can be attached to the support beam 408. The foregoing method may then be repeated to increase a vertical height of the turbine tower 2.

It is to be understood that the various components of the wind turbine 1 (e.g., the nacelle 6, the tower base 17, tower body members 16) may be delivered from a factory (not shown) to a windfarm site using a truck or trucks (not shown). Once the pad 4 has been formed at the windfarm site, either crawler crane 3 or an alternative crane may unload the various components of the wind turbine 1 from the truck(s) to a location near the pad 4 for assembly in a manner in accordance with the present disclosure. After the wind turbine 1 has been assembled, the wind turbine may then be connected to a utility grid (not shown). Should the wind turbine 1 need to be removed from the windfarm site, the wind turbine can also be disassembled. To disassemble the wind turbine, the nacelle 6 and the rotor 8 will be lowered to the base of the turbine tower 2 in a manner similar to that described above for servicing the components. The nacelle 6 will then be disconnected from the bearing 12 of the carriage 10 and the crane platform 23 would subsequently be connected. Crawler crane 3, telescoping stiff-leg crane 300, or the rotating pole assembly 400 can then be used to disassemble the turbine tower 2 in a method reverse of that described above such that tower boy members 16 can individually be disconnected and removed from the turbine tower 2 one at a time. After the turbine tower 2 is disassembled, the tower base 17 can be removed from pad 4.

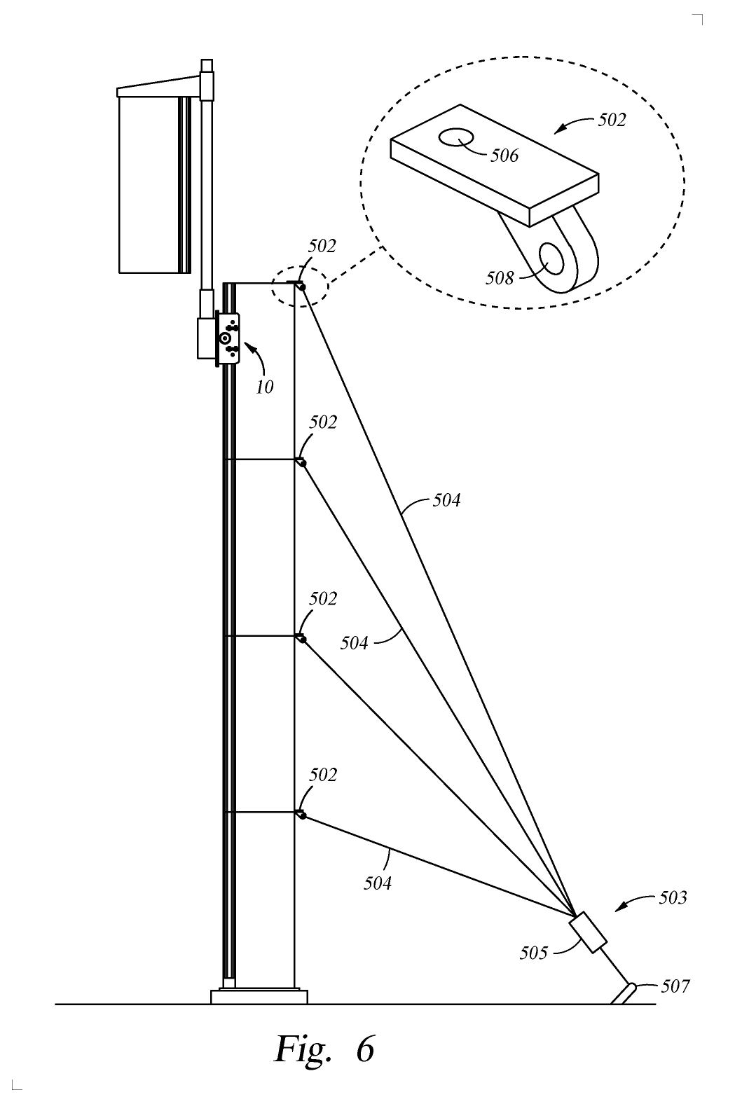

As the turbine tower 2 is being assembled, an additional support system 500 may be utilized for enhanced safety. The additional support system 500 is illustrated in FIG. 6. The additional support system 500 is shown in FIG. 6 and includes angles 502, steel cables 504, and an anchor system 503. Each angle 502 has a first end with a through-hole 506 and a second end with a through-hole 508. Each angle 502 is adapted to have the first end attached to a single member of the turbine tower 2 (e.g., tower base 17 or tower body member 16) using a fastener, and the second end attached to the anchor system 503 via steel cable 504. The fastener passes through the through-hole 506 in the first end of the angle 502 to attach the angle to the member of the turbine tower 2. The steel cable passes through the through-hole 508 in the second end of the angle 502 to attach the steel cable 504 to the angle. The steel cable 504 is then run from the angle 502 to the anchor system 503 located on a ground surface. The anchor system 503 may comprise a winch 505 and a deadman 507. The second end of the angle 502 is adapted to protrude outwardly from the member of the turbine tower 2 to which the angle is attached.

As the turbine tower 2 is being assembled, the additional support system 500 may be installed by placing one or more angles 502 between each of the tower body members 16 as they are connected to the existing turbine tower 2. For example, before an additional tower body member 16 is connected to the existing turbine tower 2, the first end of the angle 502 can be fastened to the top tower body member of the existing turbine tower 2. A steel cable 504 may subsequently be attached to the second end of the angle 502 and run to the anchor support system 503. The additional tower body member 16, which may contain a grooved region to accommodate angle 502, is then connected to the top tower body member of the existing turbine tower 2 in any manner set forth in the present disclosure. This same method of attaching an angle 502 to the top tower body member 16 of the existing turbine tower 2 may be used as each additional tower body member 16 is attached to the turbine tower. The angles 502 may be arranged to protrude outwardly from the turbine tower 2 on a side generally opposite the carriage 10. Because each of the cables attached to the second end of the angles are generally attached to the same deadman, the cables form a waterfall pattern. In this manner, the additional support system serves as a counterbalance to the weight placed upon the turbine tower 2 as a result of the carriage 10 and anything attached thereto (e.g., crane 3, crane platform 23, nacelle 6 and hub 7) moving upwardly or downwardly along the rail track 18 and rack 19. In other words, the cables of the additional support system will be in tension while the side of the turbine tower 2 to which the carriage 10 is attached will be in compression, with the tension forces and compression forces balancing each other to provide additional support to the turbine tower. It is also to be understood that the additional support system may also be used between the first tower body member and the tower base.

While the foregoing is directed to embodiments of the present disclosure, other and further embodiments of the disclosure may be devised without departing from the basic scope thereof, and the scope thereof is determined by the claims that follow.

1. A method of assembling a wind turbine, comprising:
placing a tower base in an upright position, the tower base including a tower base guide rail and a carriage, the carriage being movable along the tower base guide rail and including a crane attached thereto; and
connecting a first tower body member to the tower base to form a turbine tower, the first tower body member including a first tower body guide rail and being connected to the tower base in a manner such that the tower base guide rail axially aligns with the first tower body guide rail to collectively form a rail track, the carriage being movable up and down the turbine tower along the rail track.

2. The method of claim 1, wherein a crane platform is attached to the carriage, the crane being positioned on the crane platform.

3. The method of claim 1, wherein the tower base is placed on a pad.

4. The method of claim 1, wherein the crane is a stiff leg crane.

5. The method of claim 1, wherein the first tower body member is connected to the tower base using the crane.

6. The method of claim 5, wherein the method comprises raising the crane platform and the crane positioned thereon to a top of the tower base along the tower base guide rail and subsequently using the crane to connect the first tower body member to the tower base.

7. The method of claim 1, wherein the method comprises connecting additional tower body members to increase a vertical height of the tower turbine, each of the additional tower body members including a tower body guide rail, the additional tower body members being connected to each other and to the first tower body member in a manner such that the tower base guide rail, the first tower body guide rail, and each additional tower body guide rail axially align with each other to collectively form the rail track.

8. The method of claim 7, wherein the tower base, the first tower body member, and each of the additional tower body members are substantially identical to each other, and the method comprises connecting each of the additional tower body members using the crane.

9. The method of claim 8, wherein the method comprises raising the crane platform and the crane located thereon to a top of the turbine tower along the rail track before using the crane to connect each of the additional tower body members.

10. The method of claim 7, wherein the carriage is connected to the tower base in a vertical position and the top tower body member of the turbine tower comprises a pivot system for pivoting the carriage from the vertical position to a horizontal position when the carriage arrives at the top of the turbine tower.

11. The method of claim 10, wherein the pivot system comprises a horizontally extending guide track, the horizontally extending guide track being connected to the rail track in a manner that enables the carriage to be pivoted from the vertical position to the horizontal position when the carriage arrives at the top of the tower.

12. The method of claim 1, wherein the method comprises disconnecting the crane platform from the carriage and subsequently connecting a nacelle and hub to the carriage in a vertical position.

13. The method of claim 12, wherein the method comprises:
connecting blades to the hub to form a rotor;
raising the carriage, nacelle, and rotor along the rail track to the top of the turbine tower; and
pivoting the carriage, nacelle, and rotor from the vertical position to the horizontal position via a pivot system.

14. The method of claim 1, wherein the method comprises providing a drive system for moving the carriage up and down the turbine tower along the rail track.

15. A wind turbine comprising:
a turbine tower including a tower base and a plurality of tower body members, the tower base including a tower base guide rail, each of the plurality of tower body members including a tower body guide rail, the tower base and the plurality of tower body members being connected in a manner such that the tower base guide rail and the tower body guide rails collectively form a vertically extending rail track; and
a carriage movable along the vertically extending rail track, the carriage including a bearing that is adapted to releasably connect a crane platform having a crane positioned thereon to the turbine tower.

16. The wind turbine of claim 15, wherein the bearing is adapted to releasably connect a nacelle to the turbine tower when the bearing is not connected to a crane platform.

17. The wind turbine of claim 15, wherein each of the plurality of tower body members includes a rack, the rack of each tower body member extending along the tower body guide rail of that tower body member.

18. The wind turbine of claim 17, wherein the wind turbine comprises a drive system for moving the carriage up and down the turbine tower along the rail track, the drive system including a motor connected to the carriage and a pinion connected to a rotor of the motor, the pinion being engagable with the racks of the tower body members.

19. A method of assembling a wind turbine, comprising:
placing a tower base in an upright position, the tower base including a tower base guide rail and a carriage, the carriage including a rotating pole assembly rotatable between a loading position and an unloading position;
connecting a first tower body member to the rotating pole assembly while the rotating pole assembly is in the loading position;
moving the carriage upwardly to a top of the tower base along the tower base guide rail while the rotating pole assembly is in the loading position; and
rotating the rotating pole assembly from the loading position to the unloading position such that the first tower body member is positioned above the tower base.

20. The method of claim 19 wherein the first tower body member is connected to the tower base to form a turbine tower after rotating the rotating pole assembly from the loading position to the unloading position, the first tower body member being connected to the tower base in a manner such that the tower base guide rail axially aligns with the first tower body guide rail to collectively form a rail track, the carriage being movable up and down the turbine tower along the rail track.

21. The method of claim 20 wherein the first tower body member is disconnected from the rotating pole assembly after the first tower body member is connected to the tower base.

22. The method of claim 21 wherein the method comprises connecting additional tower body members to increase a vertical height of the tower turbine, each of the additional tower body members including a tower body guide rail, the additional tower body members being connected to each other and to the first tower body member in a manner such that the tower base guide rail, the first tower body guide rail, and each additional tower body guide rail axially align with each other to collectively form the rail track.

23. The method of claim 22 wherein each of the additional tower body members are individually connected to the turbine tower using the rotating pole assembly, each additional tower body member being individually connected to the rotating pole assembly while each additional tower body member is positioned in an upright manner on a ground surface and the rotating pole assembly is in the loading position, each additional tower body member being raised to a top of the turbine tower by the carriage moving upwardly along the rail track while the rotating pole assembly is in the loading positing, the rotating pole assembly positioning each additional tower body member above the turbine tower by rotating from the loading position to the unloading position.
